(19) United States
(12) Patent Application Publication
(10) Pub. No.: US 2009/0193026 A1
(43) Pub. Date: Jul. 30, 2009

(54) INTEGRATED DATABASE REPLAY PROTECTION

(75) Inventors: Stefan Andersson, Klagerup (SE); Marcus Liwell, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/025,865

(22) Filed: Feb. 5, 2008

Related U.S. Application Data
(60) Provisional application No. 61/023,443, filed on Jan. 25, 2008.

(51) Int. Cl. G06F 17/30

(52) U.S. Cl. 707/9; 707/E17.007

(57) ABSTRACT

An apparatus and method for providing replay protection integrity protection of a database accessible by an electronic device is provided, wherein the database is capable of protecting a plurality of records. When at least one protected record in the database is modified in an authorized manner, a record tag corresponding to the at least one protected record is stored in the database, and the at least one protected record and the corresponding record tag are copied into a cache. Upon retrieval of the at least one protected record from the database, the copied record tag stored in the cache is compared with the corresponding record tag stored in the database. Use of the retrieved protected record is inhibited if the copied record tag stored in the cache does not correspond to the record tag stored in the database, and otherwise use of the retrieved protected record is enabled.

### RELATED APPLICATION DATA

This application claims priority of U.S. Provisional Application No. 61/023,443 filed on Jan. 25, 2008, which is incorporated herein by reference in its entirety.

### TECHNICAL FIELD OF THE INVENTION

The present invention relates generally to database protection and, more particularly, to an apparatus and method for providing replay protection of a database accessible by an electronic device.

### DESCRIPTION OF THE RELATED ART

Mobile and/or wireless electronic devices are becoming increasingly popular. For example, mobile telephones, portable media players and portable gaming devices are now in wide-spread use. In addition, the features associated with certain types of electronic devices have become increasingly diverse. To name a few examples, many electronic devices have cameras, text messaging capability, Internet browsing capability, electronic mail capability, video playback capability, audio playback capability, image display capability and handsfree headset interfaces.

Certain features implemented on electronic devices may employ the use of one or more databases or the like. Such databases can store information used by software applications that reside on or are external to the electronic device. The information stored in such databases can include, for example, contacts (e.g., names and corresponding phone numbers, email addresses, etc. accessed by a contact manager), URLs (e.g., favorite web pages accessed by a web browser), file locations (e.g., locations of pictures, movies, music, etc. accessed by a content manager), etc. Additionally, the one or more databases, for example, may be stored in non-volatile memory of the electronic device (e.g., internal memory) or in memory of a removable non-volatile memory card or the like.

In certain situations it may be desirable to prevent unauthorized access to at least part of a database. This is particularly true when the data stored in the database relates to monetary data, licensing data, or any other data that should not be altered in an unauthorized manner. Exemplary approaches that can be implemented to secure the database include replay protection, integrity protection, encryption, etc. Replay protection refers to a protection scheme that prevents old valid data records from being reintroduced in the database. Such records could contain, for example, transaction counters that may be a target for an attack on the database. Integrity protection refers to ensuring data is consistent and correct, while encryption refers to the process of transforming information using an algorithm to make the information unreadable to anyone except those possessing special knowledge, usually referred to as a key.

For example, a user may purchase a license to view a movie on the electronic device, wherein the license grants the user a predetermined time period in which he may watch the movie (e.g., 1 week). This time period, along with the corresponding media content, can be stored in the database. As a user requests playback of the media content, the electronic device can retrieve from the database the time period corresponding to the media content, and compare that time period to the current date. If the current date falls within the authorized time period as specified in the database, then the electronic device will render the media content. However, if the current date falls outside the authorized time period, then the electronic device will not render the media content.

Another example applies to prepaid credits for various goods or services. This can include prepaid credits for electronically paying for goods and services (e.g., electronically buying music, paying for public transportation, access to certain toll roads, etc.). If a user wishes to pay for a particular good or service, a credit value stored in the database of the electronic device may be automatically debited from the user's database and credited to the seller. As is evident, it is desirable to prevent unauthorized modification of the credit value stored in the database.

### SUMMARY

A problem with implementing replay protection in electronic devices such as, for example, mobile phones, is that such replay protection can significantly impact performance of the electronic device. This performance impact can be due to an increased load placed on a processor of the electronic device, which in turn can result in reduced battery life and/or sluggish performance of the electronic device.

A device and method in accordance with the present invention provides a security solution that provides replay protection and integrity protection for a database, wherein a load placed on the processor is reduced relative to conventional database protection methodologies. Further, at least part of the security solution is integrated within an inner structure of the database. For example, the security measures can be stored within the database itself.

According to one aspect of the invention, a method for providing replay protection of a database accessible by an electronic device, said database capable of protecting a plurality of records, includes: when at least one protected record in the database is modified in an authorized manner, storing in the database a record tag corresponding to the at least one protected record, and copying the at least one protected record and the corresponding record tag into a cache; upon retrieval of the at least one protected record from the database, comparing the copied record tag stored in the cache with the corresponding record tag stored in the database; and inhibiting use of said retrieved protected record if the copied record tag stored in the cache does not correspond to the record tag stored in the database, and otherwise enabling use of said retrieved protected record.

According to one aspect of the invention, the method further includes sizing the cache such that a number of records stored within the cache is less than a number of records stored in the database.

According to one aspect of the invention, the plurality of protected records are records indicative of a monetary value.

According to one aspect of the invention, the plurality of protected records are records indicative of a number of allowed uses of licensed content or of an allowed rendering period of the licensed content.

According to one aspect of the invention, the method further includes randomly deleting a protected record and corresponding record tag from the cache when the cache is full and another protected record and corresponding record tag are being copied into the cache.

According to one aspect of the invention, the record tag comprises a time stamp indicative of a time and/or date that the protected record is modified or entered in the database.

According to one aspect of the invention, the record tag comprises a random number or code that is unique for each protected record.

According to one aspect of the invention, inhibiting use of said retrieved protected record includes deleting the retrieved protected record from the database.

According to one aspect of the invention, the method further includes storing the cache in a protected memory area.

According to one aspect of the invention, the method further includes randomly deleting records in the cache such that an attacker will not know which records are protected.

According to one aspect of the invention, a portable electronic device for providing replay protection of a database capable of storing a plurality of protected records includes: a processor and memory; a cache stored in said memory and accessible by the processor; replay protection logic stored in said memory and executable by the processor, said replay protection logic including i) logic that when at least one protected record in a database accessible by the electronic device is modified in an authorized manner, stores in the database a record tag corresponding to the at least one protected record, and copies the at least one protected record and the corresponding record tag into said cache, ii) logic that upon retrieval of the at least one protected record from the database compares the copied record tag stored in the cache with the corresponding record tag stored in the database, and iii) logic that inhibits use of said retrieved protected record if the copied record tag stored in the cache does not correspond to the record tag stored in the database, and otherwise enables use of said retrieved protected record.

According to one aspect of the invention, a number of records stored within the cache is less than a number of records stored in the database.

According to one aspect of the invention, the plurality of protected records are records indicative of a monetary value.

According to one aspect of the invention, the plurality of protected records are records indicative of a number of allowed uses of licensed content or of an allowed rendering period of the licensed content.

According to one aspect of the invention, the electronic device further includes logic that randomly deletes a protected record and corresponding record tag from the cache when the cache is full and another protected record and corresponding record tag are being copied into the cache.

According to one aspect of the invention, the record tag comprises a time stamp indicative of a time and/or date that the record is modified or entered in the database.

According to one aspect of the invention, the record tag comprises a random number or code that is unique for each protected record.

According to one aspect of the invention, the logic that inhibits use of said retrieved protected record includes logic that deletes the retrieved protected record from the database.

According to one aspect of the invention, the electronic device further includes comprising call circuitry for establishing two-way wireless communications.

According to one aspect of the invention, the electronic device is at least one of a mobile phone, pager, electronic organizer, personal digital assistant, or smartphone.

According to one aspect of the invention, the cache is formed in a protected memory area.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic view of a mobile telephone as an exemplary electronic device in accordance with an embodiment of the present invention.

FIG. 2 is a schematic block diagram of the relevant portions of the mobile telephone of FIG. 1 in accordance with an embodiment of the present invention.

FIG. 3 is a schematic diagram of a communications system in which the mobile telephone of FIG. 1 may operate.

FIG. 4 is an exemplary database that includes a security entry in accordance with the invention.

FIG. 5 is an exemplary record replay cache in accordance with the invention.

FIG. 6 is a flow chart representing an exemplary method of implementing replay protection in accordance with the invention.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

The interchangeable terms “electronic equipment” and “electronic device” include portable radio communication equipment. The term “portable radio communication equipment,” which hereinafter is referred to as a “mobile radio terminal,” includes all equipment such as mobile telephones, pagers, communicators, electronic organizers, personal digital assistants (PDAs), smartphones, portable communication apparatus or the like.

In the present application, embodiments of the invention are described primarily in the context of a mobile telephone. However, it will be appreciated that the invention is not intended to be limited to the context of a mobile telephone and may relate to any type of appropriate electronic equipment, examples of which include a media player, a gaming device and a computer.

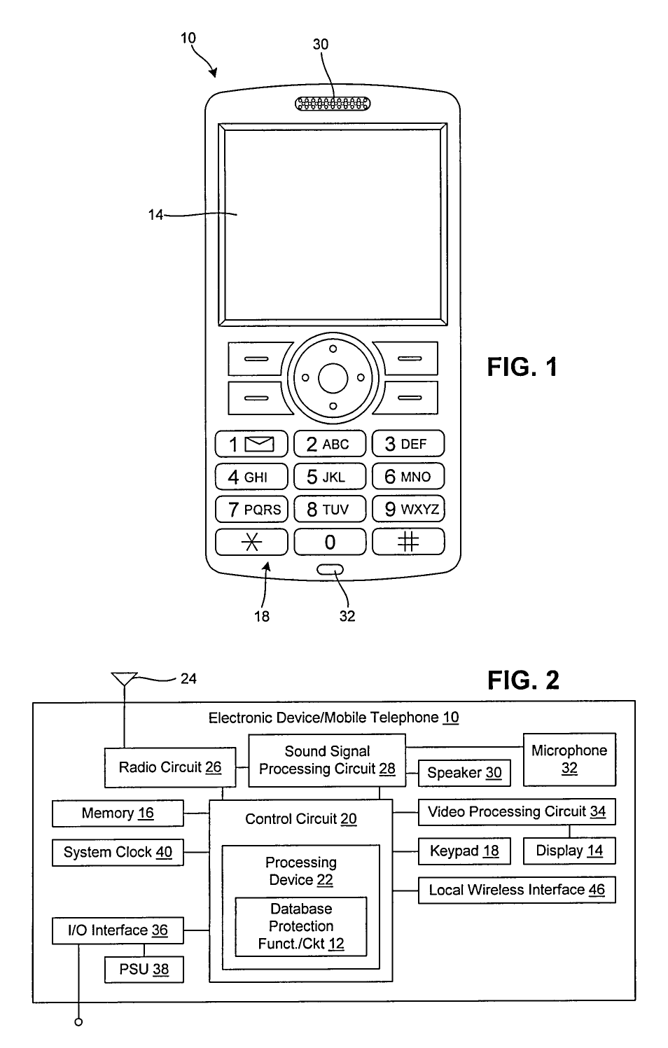

Referring initially to FIGS. 1 and 2, an electronic device 10 is shown. The electronic device 10 includes replay protection function 12 that is configured to provide replay protection for data (e.g., a database or the like) stored on or accessible by the electronic device. Further, the database replay function 12 does not utilize significant processing power, thereby increasing battery life and freeing resources for other tasks. Additional details and operation of the replay protection function 12 will be described in greater detail below. The replay protection function 12 may be embodied as executable code that is resident in and executed by the electronic device 10. In one embodiment, the replay protection function 12 may be a program stored on a computer or machine readable medium. The replay protection function 12 may be a stand-alone software application or form a part of a software application that carries out additional tasks related to the electronic device 10.

The electronic device of the illustrated embodiment is a mobile telephone and will be referred to as the mobile telephone 10. The mobile telephone 10 is shown as having a “brick” or “block” form factor housing, but it will be appreciated that other housing types may be utilized, such as a “flip-open” form factor (e.g., a “clamshell” housing) or a slide-type form factor (e.g., a “slider” housing).

The mobile telephone 10 may include a display 14. The display 14 displays information to a user such as operating state, time, telephone numbers, contact information, various navigational menus, etc., which enable the user to utilize the various features of the mobile telephone 10. The display 14 also may be used to visually display content received by the mobile telephone 10 and/or retrieved from a memory 16 (FIG. 2) of the mobile telephone 10. The display 14 may be used to present images, video and other graphics to the user, such as photographs, mobile television content and video associated with games.

A keypad 18 provides for a variety of user input operations. For example, the keypad 18 typically includes alphanumeric keys for allowing entry of alphanumeric information such as telephone numbers, phone lists, contact information, notes, etc. In addition, the keypad 18 typically includes special function keys such as a “call send” key for initiating or answering a call, and a “call end” key for ending or “hanging up” a call. Special function keys also may include menu navigation and select keys to facilitate navigating through a menu displayed on the display 14. For instance, a pointing device and/or navigation keys may be present to accept directional inputs from a user. Special function keys may include audiovisual content playback keys to start, stop and pause playback, skip or repeat tracks, and so forth. Other keys associated with the mobile telephone may include a volume key, an audio mute key, an on/off power key, a web browser launch key, a camera key, etc. Keys or key-like functionality also may be embodied as a touch screen associated with the display 14. Also, the display 14 and keypad 18 may be used in conjunction with one another to implement soft key functionality.

The mobile telephone 10 includes call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc. Another example includes a video enabled call that is established over a cellular or alternative network.

The mobile telephone 10 may be configured to transmit, receive and/or process data, such as text messages (e.g., a text message is commonly referred to by some as “an SMS,” which stands for short message service), instant messages, electronic mail messages, multimedia messages (e.g., a multimedia message is commonly referred to by some as “an MMS,” which stands for multimedia message service), image files, video files, audio files, ring tones, streaming audio, streaming video, data feeds (including podcasts) and so forth. Processing such data may include storing the data in the memory 16, executing applications to allow user interaction with data, displaying video and/or image content associated with the data, outputting audio sounds associated with the data and so forth.

FIG. 2 represents a functional block diagram of the mobile telephone 10. For the sake of brevity, generally conventional features of the mobile telephone 10 will not be described in great detail herein. The mobile telephone 10 includes a primary control circuit 20 that is configured to carry out overall control of the functions and operations of the mobile telephone 10. The control circuit 20 may include a processing device 22, such as a CPU, microcontroller or microprocessor. The processing device 22 executes code stored in a memory (not shown) within the control circuit 20 and/or in a separate memory, such as the memory 16, in order to carry out operation of the mobile telephone 10. The memory 16 may be, for example, one or more of a buffer, a flash memory, a hard drive, a removable media, a volatile memory, a non-volatile memory, a random access memory (RAM), or other suitable device.

In addition, the processing device 22 may execute code that implements the replay protection function 12. It will be apparent to a person having ordinary skill in the art of computer programming, and specifically in application programming for mobile telephones or other electronic devices, how to program a mobile telephone 10 to operate and carry out logical functions associated with the replay protection function 12 as described herein. Accordingly, details as to specific programming code have been left out for the sake of brevity. Also, while the replay protection function 12 is executed by the processing device 22 in accordance with a preferred embodiment of the invention, such functionality could also be carried out via dedicated hardware, firmware, software, or combinations thereof, without departing from the scope of the invention. Any of these implementations may be referred to as a replay protection circuit 12.

Continuing to refer to FIGS. 1 and 2, the mobile telephone 10 includes an antenna 24 coupled to a radio circuit 26. The radio circuit 26 includes a radio frequency transmitter and receiver for transmitting and receiving signals via the antenna 24 as is conventional. The radio circuit 26 may be configured to operate in a mobile communications system and may be used to send and receive data and/or audiovisual content. Receiver types for interaction with a mobile radio network and/or broadcasting network include, but are not limited to, GSM, CDMA, WCDMA, GPRS, WiFi, WiMax, DVB-H, ISDB-T, etc., as well as advanced versions of these standards.

The mobile telephone 10 further includes a sound signal processing circuit 28 for processing audio signals transmitted by and received from the radio circuit 26. Coupled to the sound processing circuit 28 are a speaker 30 and a microphone 32 that enable a user to listen and speak via the mobile telephone 10 as is conventional. The radio circuit 26 and sound processing circuit 28 are each coupled to the control circuit 20 so as to carry out overall operation. Audio data may be passed from the control circuit 20 to the sound signal processing circuit 28 for playback to the user. The audio data may include, for example, audio data from an audio file stored by the memory 16 and retrieved by the control circuit 20, or received audio data such as in the form of streaming audio data from a mobile radio service. The sound processing circuit 28 may include any appropriate buffers, decoders, amplifiers and so forth.

The display 14 may be coupled to the control circuit 20 by a video processing circuit 34 that converts video data to a video signal used to drive the display 14. The video processing circuit 34 may include any appropriate buffers, decoders, video data processors and so forth. The video data may be generated by the control circuit 20, retrieved from a video file that is stored in the memory 16, derived from an incoming video data stream that is received by the radio circuit 28 or obtained by any other suitable method.

The mobile telephone 10 may further include one or more I/O interface(s) 36. The I/O interface(s) 36 may be in the form of typical mobile telephone I/O interfaces and may include one or more electrical connectors. As is typical, the I/O interface(s) 36 may be used to couple the mobile telephone 10 to a battery charger to charge a battery of a power supply unit (PSU) 38 within the mobile telephone 10. In addition, or in the alternative, the I/O interface(s) 36 may serve to connect the mobile telephone 10 to a headset assembly (e.g., a personal handsfree (PHF) device) that has a wired interface with the mobile telephone 10. Further, the I/O interface(s) 36 may serve to connect the mobile telephone 10 to a personal computer or other device via a data cable for the exchange of data. The mobile telephone 10 may receive operating power via the I/O interface(s) 36 when connected to a vehicle power adapter or an electricity outlet power adapter.

The mobile telephone 10 also may include a system clock 40 for clocking the various components of the mobile telephone 10, such as the control circuit 20. The control circuit 20 may, in turn, carry out timing functions, such as timing the durations of calls, generating the content of time and date stamps, and so forth.

The mobile telephone 10 also may include a local wireless interface 46, such as an infrared transceiver and/or an RF interface (e.g., a Bluetooth interface), for establishing communication with an accessory, another mobile radio terminal, a computer or another device. For example, the local wireless interface 46 may operatively couple the mobile telephone 10 to a headset assembly (e.g., a PHF device) in an embodiment where the headset assembly has a corresponding wireless interface.

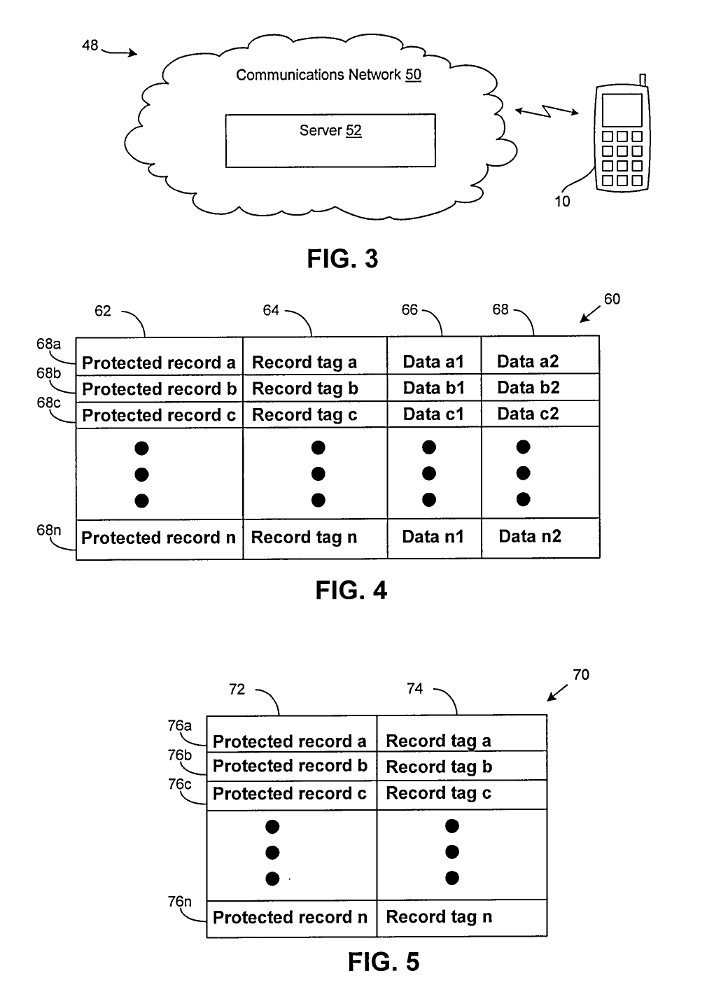

With additional reference to FIG. 3, the mobile telephone 10 may be configured to operate as part of a communications system 48. The system 48 may include a communications network 50 having a server 52 (or servers) for managing calls placed by and destined to the mobile telephone 10, transmitting data to the mobile telephone 10 and carrying out any other support functions. The server 52 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 50 may support the communications activity of multiple mobile telephones 10 and other types of end user devices. As will be appreciated, the server 52 may be configured as a typical computer system used to carry out server functions and may include a processor configured to execute software containing logical instructions that embody the functions of the server 52 and a memory to store such software.

As noted above, the mobile telephone 10 also includes the replay protection function 12. The replay protection function 12 provides a security solution for data stored on or accessible by an electronic device, such as a mobile telephone. The replay protection function 12 in accordance with the invention will be described below in the framework of licensed media content and wireless payment methods. It will be appreciated, however, that the replay protection in accordance with the invention may be utilized in numerous other applications, and discussion with respect to licensing media content and wireless payment methods are merely exemplary.

In licensing media content to an end user, it may be desirable to limit a number of times the user may view or otherwise render the media content on the electronic device 10 (e.g., the user may render the content five times before additional payment is required), or to limit a time frame in which the media content may be rendered on the electronic device (e.g., the user may render the media content for one week after payment). Movie and music content are two examples of media content that may be licensed in this manner. Data pertaining to a number of plays or a time period in which the media content may be rendered is referred to herein as “expiration criteria”, and this expiration criteria may be stored in the electronic device 10. Prior to each rendering of the media content 10, the expiration criteria are checked to determine if it is permissible to render the content. Depending on the specifics of each file and the associated expiration criteria, the media content is or is not rendered on the electronic device 10.

Another example pertains to wireless payment for certain services, such as public transportation and/or use of toll roads. For example, a user may prepay for a number of credits, which are then stored in the database of the electronic device 10. These prepaid credits may be used for public transportation (e.g., riding a bus), to pay tolls, etc. For example, prior to riding the bus the user may pass the electronic device 10 near a wireless reader, which retrieves data (e.g., data corresponding to prepaid credits) from the electronic device 10. A check then may be performed to determine if the electronic device has sufficient credits stored thereon to allow the user to purchase a bus ticket and, if so, then a bus ticket may be issued and/or access to the bus may be granted. Further, the number of credits stored in the electronic device 10 is decremented corresponding to the fee for riding the bus.

If an attack is made on the database such that unauthorized access is obtained to the records associated with the above-discussed expiration criteria and/or credits, it is possible that these records may be compromised, which is undesirable. To avoid unauthorized modification of the records (e.g., to prevent an attacker from changing data values so as to enable longer use of the content or increased number of credits), a form of replay protection can be implemented.

The replay protection implemented in accordance with the present invention minimizes a load placed on the processing device 22 of the electronic device 10. This is particularly advantageous, as when processing load is decreased, power requirements are also decreased, which tends to conserve battery life. Further, since the processing load created by the replay protection is minimized, the protection scheme does not adversely affect performance of the electronic device 10.

Moreover, replay protection in accordance with the invention is configured so as to implement at least part of a protection mechanism in the database. For example, each protected record (or group of commonly protected records) in the database includes a corresponding record tag. The record tag can be a time stamp, for example, wherein the time stamp corresponds to a time and/or date in which the protected record was entered into the database or last modified. Alternatively, the record tag may comprise a unique code or number (e.g., a randomly generated code or number).

FIG. 4 illustrates an exemplary database 60 that may be used to implement replay protection in accordance with the invention. The database 60 includes a first column 62 for storing a plurality of protected records, and a second column 64 for storing a plurality of corresponding record tags. The database 60 also may include additional columns 66 and 68 for storing data related to the protected data. The database 60 also includes a plurality of rows 68a-68n, wherein each row corresponds to a protected record, record tag, and other data corresponding to the protected record.

Upon entry and/or modification of a record in the database, a corresponding entry is made in a cache stored in memory 16 of the electronic device. Preferably the memory is a protected area of memory that cannot be readily accessed. The data entered into the cache includes the protected record and the corresponding record tag. Thus, under normal operation, the database 60 and cache each include the same protected records and the corresponding record tags for the protected records. The other related data of columns 66 and 68 need not be stored in the cache to implement replay protection in accordance with the invention.

FIG. 5 illustrates an exemplary cache 70 that may be used to implement replay protection in accordance with the invention. The cache 70 includes a first column 72 for storing a plurality of protected records, and a second column 74 for storing a plurality of corresponding record tags. As explained in more detail below, the first column 72 and second column 74 of the cache 70 correspond to the first column 62 and second column 64 of the database 60. The cache 70 also includes a plurality of rows 76a-76n, wherein each row corresponds to a protected record.

Prior to enabling use of a protected record retrieved from the database 60, a comparison is made between the record tag for the protected record as stored in the database 60 with the corresponding record tag as stored in the cache 70. If the two record tags match or otherwise correspond to one another, then use of the protected record is permitted. If the two record tags do not match or otherwise do not correspond to one another, then it is presumed that the database 60 has been compromised and use of the protected record is not permitted. Further, the compromised protected record may be deleted from the database 60.

Preferably, a number of records stored in the cache 70 is less than a number of records stored in the database 60 (e.g., a number of rows 76a-76n of the cache 70 is less than a number of rows 68a-68n of the database 60, or the total number of protected records and corresponding record tags of the database are less than a total number of protected records and record tags of the cache). Further, if a new protected record and corresponding record tag are to be stored in the cache 70 and the cache is full (e.g., all available rows in the cache have been used to store a protected record and record tag), then an existing entry in the cache 70 can be randomly selected for deletion to make room for new incoming protected record and record tag. Randomly deleting an entry in the cache 70 makes it more difficult for an attacker to determine which records 76a-76n are active in the cache 70 and, thus, replay protected.

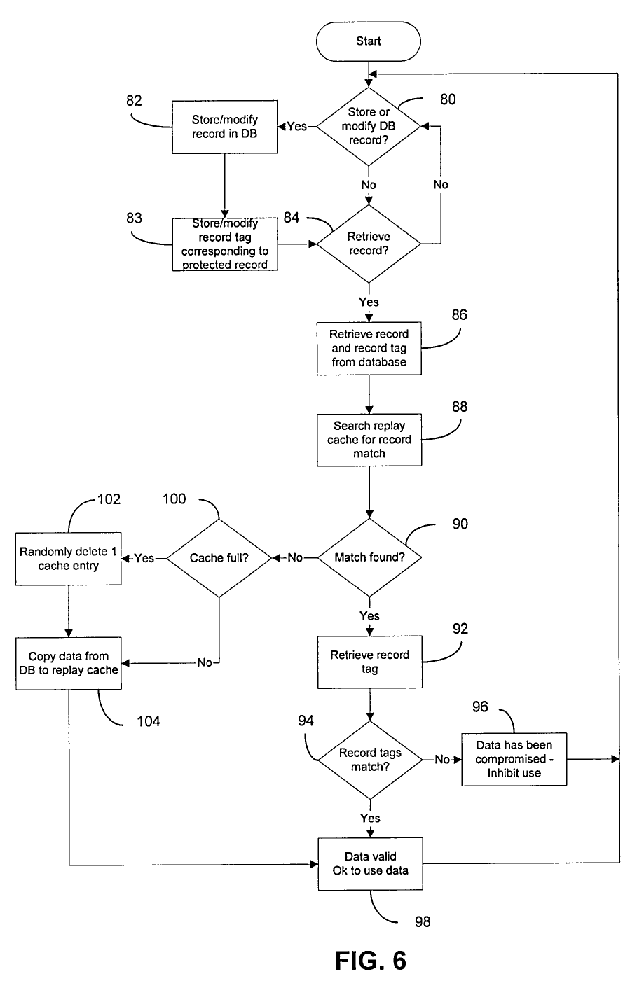

With additional reference to FIG. 6, illustrated are logical operations to implement an exemplary method of replay protection in accordance with the invention. The exemplary method may be carried out by executing an embodiment of the replay protection function 12, for example. Thus, the flow chart of FIG. 6 may be thought of as depicting steps of a method carried out by the mobile telephone 10. Although FIG. 6 shows a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, commands, state variables, semaphores or messages may be added to the logical flow for purposes of enhanced utility, accounting, performance, measurement, troubleshooting, and the like. It is understood that all such variations are within the scope of the present invention.

The logical flow for the replay protection function 12 may begin in block 80 where it is determined if a new protected record will be entered into the database 60, or if an existing protected record will be modified. If a new protected record will be entered or an existing protected record modified, then at block 82 the database 60 is accessed, the protected record is entered and/or modified in a conventional manner. Next at block 83, a record tag corresponding to the modified protected record is entered or otherwise updated in the database 60. As noted herein, the record tag can be a time stamp corresponding to the moment when the protected record was entered or modified in the database 60. Other means of implementing a record tag include random numbers, codes, etc. After the record tag has been entered or updated, the method moves to block 84. If a new record will not be made and an existing protected record will not be modified, then the method moves directly to block 84.

At block 84, it is determined if a protected record will be retrieved from the database 60 for use by another application. For example, prior to rendering a movie, a request for a protected record pertaining to expiration data (e.g., data indicative of a valid rendering period) may be made, and that data may be used to enable or disable rendering of the movie. If a protected record will not be retrieved from the database 60, then the method moves back to block 80 and repeats the above-described steps. If a protected record will be retrieved from the database 60, then at block 86 the protected record and corresponding record tag are retrieved, and at block 88 a search is performed for the protected record in the cache 70.

At block 90, it is determined if the cache 70 includes a protected record that matches the protected record retrieved from the database 60. If the cache 70 does contain the same protected record, then at block 92 the corresponding record tag is also retrieved from the cache 70. At block 94, the record tag as retrieved from the database 60 is compared to the record tag as retrieved from the cache 70. If the two record tags match or otherwise correspond to one another, then the database 60 is presumed to be secure and use of the protected record is allowed as indicated at block 98. However, if the two record tags do not match or otherwise do not correspond to one another, then it is presumed that the database 60 has been compromised, and use of the protected record is not allowed (which prevents rendering of the media content, for example) as indicated at block 96. Optionally, the compromised protected record can be deleted from the database 60.

Moving back to block 90, if the protected record retrieved from the database 60 is not found in the cache 70, then the current protected record has not yet been stored in the cache 70. The method then proceeds to store the protected record and corresponding record tag in the cache 70. However, prior to storing the protected record and corresponding record tag, it is determined at block 100 if the cache is full (i.e., whether all available record entries in the cache have been used). As noted herein, the cache 70 is preferably sized to store fewer records than the database 60. That is, the number of records (i.e., protected records and corresponding record tags) that can be stored in the cache 70 is preferably less than the number of records that can be stored in the database 60.

If the cache is full, then at block 102 a protected record and corresponding record tag is randomly selected from the cache 70 and deleted. Deleting an entry from the cache 70 frees up space for the incoming protected record and record tag. While a first-in first-out scheme may be implemented to delete old records, such approach is somewhat easier for an attacker to circumvent than when the records are randomly deleted, as the attacker is never sure which records are the active records and which records are old records that are no longer valid. Next at block 104, the incoming protected record and corresponding record tag are copied into the cache 70. Moving back to block 100, if the cache is not full, then the method moves directly to block 104 and the incoming protected record and corresponding record tag are copied into an available location of the cache 70. Next, the method moves to block 98 and use of the protected record is enabled.

Accordingly, a method and apparatus for implementing replay protected in an electronic device is provided. Replay protection in accordance with the invention is advantageous relative to other means for protecting databases in electronic devices, as a load placed on a processor of the electronic device while implementing the replay protection described herein is less than a load placed on the processor while implementing conventional protection schemes. This is due at least in part to the fact that replay protection as described herein is implemented for a selected record, and not for the entire database.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A method for providing replay protection of a database accessible by an electronic device, said database capable of protecting a plurality of records, comprising:
when at least one protected record in the database is modified in an authorized manner, storing in the database a record tag corresponding to the at least one protected record, and copying the at least one protected record and the corresponding record tag into a cache;
upon retrieval of the at least one protected record from the database, comparing the copied record tag stored in the cache with the corresponding record tag stored in the database; and
inhibiting use of said retrieved protected record if the copied record tag stored in the cache does not correspond to the record tag stored in the database, and otherwise enabling use of said retrieved protected record.

2. The method according to claim 1, further comprising sizing the cache such that a number of records stored within the cache is less than a number of records stored in the database.

3. The method according to claim 1, wherein said plurality of protected records are records indicative of a monetary value.

4. The method according to claim 1, wherein said plurality of protected records are records indicative of a number of allowed uses of licensed content or of an allowed rendering period of the licensed content.

5. The method according to claim 1, further comprising randomly deleting a protected record and corresponding record tag from the cache when the cache is full and another protected record and corresponding record tag are being copied into the cache.

6. The method according to claim 1, wherein the record tag comprises a time stamp indicative of a time and/or date that the protected record is modified or entered in the database.

7. The method according to claim 1, wherein the record tag comprises a random number or code that is unique for each protected record.

8. The method according to claim 1, wherein inhibiting use of said retrieved protected record includes deleting the retrieved protected record from the database.

9. The method according to claim 1, further comprising storing the cache in a protected memory area.

10. The method according to claim 1, further comprising randomly deleting records in the cache such that an attacker will not know which records are protected.

11. A portable electronic device for providing replay protection of a database capable of storing a plurality of protected records, comprising:
a processor and memory;
a cache stored in said memory and accessible by the processor;
replay protection logic stored in said memory and executable by the processor, said replay protection logic including
logic that when at least one protected record in a database accessible by the electronic device is modified in an authorized manner, stores in the database a record tag corresponding to the at least one protected record, and copies the at least one protected record and the corresponding record tag into said cache;
logic that upon retrieval of the at least one protected record from the database compares the copied record tag stored in the cache with the corresponding record tag stored in the database; and
logic that inhibits use of said retrieved protected record if the copied record tag stored in the cache does not correspond to the record tag stored in the database, and otherwise enables use of said retrieved protected record.

12. The electronic device according to claim 11, wherein a number of records stored within the cache is less than a number of records stored in the database.

13. The electronic device according to claim 11, wherein said plurality of protected records are records indicative of a monetary value.

14. The electronic device according to claim 11, wherein said plurality of protected records are records indicative of a number of allowed uses of licensed content or of an allowed rendering period of the licensed content.

15. The electronic device according to claim 11, further comprising logic that randomly deletes a protected record and corresponding record tag from the cache when the cache is full and another protected record and corresponding record tag are being copied into the cache.

16. The electronic device according to claim 11, wherein the record tag comprises a time stamp indicative of a time and/or date that the record is modified or entered in the database.

17. The electronic device according to claim 11, wherein the record tag comprises a random number or code that is unique for each protected record.

18. The electronic device according to claim 11, wherein the logic that inhibits use of said retrieved protected record includes logic that deletes the retrieved protected record from the database.

19. The electronic device according to claim 11, further comprising call circuitry for establishing two-way wireless communications.

20. The electronic device according to claim 11, wherein the electronic device is at least one of a mobile phone, pager, electronic organizer, personal digital assistant, or smartphone.

21. The electronic device according to claim 11, wherein the cache is formed in a protected memory area.
